(19) United States
(12) Patent Application Publication
(10) Pub. No.: US 2018/0077948 A1
(43) Pub. Date: Mar. 22, 2018

(54) GUMMY CONFECTIONERY COMPOSITION

(71) Applicant: Teena Marilyn Gudjonson, Salmon Arm (CA)

(72) Inventor: Teena Marilyn Gudjonson, Salmon Arm (CA)

(21) Appl. No.: 15/706,245

(22) Filed: Sep. 15, 2017

Related U.S. Application Data
(60) Provisional application No. 62/395,650, filed on Sep. 16, 2016.

(51) Int. Cl. A23G 3/36; A23G 3/34; C12G 1/00; C12G 3/00

(52) U.S. Cl. CPC A23G 3/36; A23G 3/0004; A23V 2002/00; C12G 3/00; C12G 1/00

(57) ABSTRACT

The present disclosure relates to a gummy confectionery composition comprising: a gummy matrix and one or more components derived from an alcoholic beverage, the one or more components contained within the gummy matrix; or a gummy matrix and alcohol contained within the gummy matrix. The gummy matrix is derived from ingredients comprising a gelling agent, a sweetener, and a texturizing agent. The present disclosure also relates to a process of manufacturing gummy confectionery composition. The process comprises mixing at least a gelling agent and fluid sweetener to form a first mixture, heating the first mixture to a simmer, reducing the heat applied to the first mixture to below the simmering temperature, and mixing an alcohol containing solution and a texturizing agent with the first mixture. The second mixture may comprise 10-60 wt % of the alcohol containing solution, 15-30 wt % of the gelling agent, and 20-70 wt % of the sweetener.

### CROSS-REFERENCE

This application claims priority from provisional application 62/395,650, the content of which are incorporated herein in its entirety.

### TECHNICAL FIELD

The present disclosure relates to a gummy confectionery composition comprising one or more components derived from an alcohol containing solution, and a method of manufacturing said gummy confectionery composition. The present disclosure also relates to a gummy confectionery composition comprising alcohol, and a method of manufacturing said gummy confectionery composition.

### BACKGROUND

Alcoholic beverages are enjoyed worldwide. Some alcoholic beverages may contain very few ingredients; other alcoholic beverages may be complex mixtures. For example, wines are complex mixtures that naturally contain a variety of acids such as, but not limited to, tartaric acid, malic acid, lactic acid, and tannic acid. Acids play an important role in wine production. For example, the molar ratios of acids within a wine, among other variables, directly influence the characteristics of the wine including, but not limited to, the taste, the colour, and the balance of the wine. Owing to its high acidic content, wines generally have a pH of between about 3 and about 4.

Alcoholic beverages (e.g. wines, beers, spirits, liqueurs, and ciders) may be enjoyed in confectionery form. Many alcohol manufacturers have their own novelty candy lines. Such candies include, but are not limited to, whiskey fudge caramels, beer dark chocolate truffles, and liquor filled chocolates. Hard, brittle candies (e.g. chocolates) comprising or encapsulating an alcoholic filling are well known and popular.

Gummy confectionery compositions (e.g. gummi candy, jelly candy) are also well known. A gummy confectionery composition comprises a gummy matrix that substantially forms the body of the gummy confectionery composition. The gummy matrix may be prepared from a boiled mixture of sweeteners (e.g. sugar) and one or more gelling agents. Non-limiting examples of gelling agents include agar, gelatin, starch, gum Arabic, and pectin. Gummy confectionery compositions are typically cast into moulds or extruded, and then refrigerated to achieve their final form.

Gummy confectionery compositions comprising one or more components derived from wine or other alcohol containing solution, however, are not common. For example, “wine gums” (the pastille-type sweet that is similar to a gumdrop) do not contain any alcohol, but are named such for the fruit flavours that linger in the after-taste, much like how a wine may linger in the after-taste. Without being bound by theory, it is believed that acids that are native to wines or other alcohol containing solution generally react with gelling agents during the manufacturing process of gummy confectionery compositions, and, as a result, reduce the ability of the gelling agent to bind and impart texture to the confectionery composition. In addition, heat is necessarily required for the manufacturing of gummy confectionery compositions. Elevated temperatures sustained for prolonged periods of time lead to the evaporation of alcohol (e.g. ethanol), and therefore the removal of the alcohol from the gummy confectionery composition.

For at least these foregoing reasons, it has been difficult to produce a gummy confectionery composition comprising one or more components derived from an alcohol containing solution (e.g. an alcoholic beverage). It has also been difficult to prepare a gummy matrix while using an alcohol containing solution (e.g. an alcoholic beverage) as an “ingredient” thereof. It has also been difficult to produce a gummy confectionery composition comprising a gummy matrix and alcohol contained within the gummy matrix.

### SUMMARY

The present disclosure relates to a gummy confectionery composition comprising one or more components derived from an alcoholic beverage, and a method of manufacturing said gummy confectionery composition. The present disclosure also relates to a gummy confectionery composition comprising alcohol, and a method of manufacturing said gummy confectionery composition.

The disclosure, in a part, describes a process of manufacturing a gummy confectionery composition comprising: (i) a gummy matrix and one or more components derived from an alcoholic beverage, the one or more components contained within the gummy matrix; or (ii) a gummy matrix and alcohol contained within the gummy matrix.

The process comprises the steps of: (a) mixing a gelling agent and a sweetener together to form a first mixture; (b) heating the first mixture to a simmer; (c) mixing an alcohol containing solution, a texturizing agent, and a weak acid into the first mixture, thereby forming a second mixture; (d) maintaining the temperature of the second mixture to a temperature between about 30° C. and about 90° C.; and (e) refrigerating the second mixture at a temperature between −20° C. and 15° C.

The disclosure, in another part, describes a gummy confectionery composition comprising: (i) a gummy matrix and one or more components derived from an alcoholic beverage, the one or more components contained within the gummy matrix; or (ii) a gummy matrix and alcohol contained within the gummy matrix.

The gummy confectionery composition prepared by a process comprising the steps of: (a) mixing a gelling agent and a sweetener to form a first mixture; (b) heating the first mixture to a simmer; (c) mixing an alcohol containing solution and a texturizing agent with the first mixture, thereby forming a second mixture; (d) reducing the temperature of the second mixture to a temperature between about 30° C. and about 90° C.; and (e) refrigerating the second mixture at a temperature between −20° C. and 15° C.

The second mixture may comprise 10 wt % to 60 wt % of the alcohol containing solution. For example, the second solution may comprise 10 wt % to 50 wt %, 10 wt % to 40 wt %, 10 wt % to 30 wt %, 10 wt % to 20 wt % of the alcohol containing solution.

The alcohol containing solution may be an alcoholic beverage. The alcoholic beverage may be a wine, beer, spirit, liqueur, cider, or a combination thereof. The spirit may be a gin, vodka, rum, whiskey, tequila, moonshine, brandy, or a combination thereof.

The second mixture may comprise 15 wt % to 30 wt % of the gelling agent.

The second mixture may comprise 20 wt % to 70 wt % of the sweetener.

The second mixture may comprise 0.1 wt % to 0.5 wt % of the weak acid.

The first mixture may be cooled to a temperature of between about 30° C. and about 90° C. prior to the addition of the alcohol containing solution into the first mixture.

The first mixture may be maintained at a simmer for about 5 to about 30 minutes.

This summary does not necessarily describe the entire scope of all aspects of the disclosure. Other aspects, features and advantages will be apparent to those of ordinary skill in the art upon review of the following description of specific embodiments.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

As used herein, the terms “comprising,” “having,” “including” and “containing,” and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method or use functions. The term “consisting of” when used herein in connection with a composition, use or method, excludes the presence of additional elements and/or method steps.

As used herein, the term “about”, when used to describe a recited value, means within 10% of the recited value.

As used herein, the term “alcohol containing solution” includes, but is not limited to, examples such as an “alcoholic beverage” and an “ethanol solution”.

As used herein, the term “alcoholic beverage” means a liquid refreshment commercially sold for human consumption, the liquid refreshment containing a measurable alcohol (e.g. ethanol) content. The term “alcoholic beverage” further includes any de-alcoholized versions and non-alcoholic versions of such liquid refreshments. Non-limiting examples of “alcoholic beverages” herein include wines, dealcoholized wines, non-alcoholic wines, beers, dealcoholized beers, and non-alcoholic beers.

As used herein, the term “derived” means to come from. For example, ethanol is a component of alcoholised wine; ethanol that is “derived” from alcoholised wine means ethanol that has come from the alcoholised wine or has evolved from the production of such alcoholised wine.

As used herein, the term “ethanol solution” refers to an ethanol reagent that is commercially available through a chemical supplier.

As used herein, the term “gelling agent” refers to a compound or composition used to impart gel-like or thickening quality upon the addition of moisture or liquid.

As used herein, the term “gummy” refers to a longer and elastic texture that enables an individual to continue chewing.

As used herein, the term “simmer” refers to a state or temperature of a fluid medium (e.g. a “first mixture” as described below) that is just below the boiling point of the fluid medium.

As used herein, the term “sweetener” refers to a compound that imparts a sweet taste to a composition and/or masks other unpleasant tastes of the composition.

As used herein, the term “texturizing agent” refers to a compound that is capable of modulating the texture of a composition.

### Gummy Confectionery Composition

The present disclosure relates, in part, to a gummy confectionery composition. The gummy confectionery composition may be a soft chewable candy. Examples of soft chewable candies include, but are not limited to, starch-based candies, agar-based candies, gelatin-based candies, and candies comprising a hydrocolloid texturizing agent as an ingredient.

According to a first embodiment of a confectionery composition described herein, there is a gummy confectionery composition comprising: (i) a gummy matrix; and (ii) one or more components derived from an alcoholic beverage and contained within the gummy matrix. For clarity, said one or more components is contained within the gummy matrix or forms a part of the gummy matrix.

The gummy matrix is derived from ingredients comprising a gelling agent, a sweetener, and a texturizing agent. As described later in this disclosure, the gelling agent, sweetener, and texturizing agent may be combined together in a suitable ratio for producing the gummy matrix.

The gelling agent can be any suitable gelling agent. Examples of gelling agents include, but are not limited to, starch (e.g. natural and/or modified), gelatin, agar, beef gelatine, acacia, alginic acid, bentonite, carbomers, carboxymethyl cellulose, ethylcellulose, gelatin, hydroxyethyl cellulose, hydroxypropyl cellulose, magnesium aluminum silicate, methylcellulose, poloxamers, polyvinyl alcohol, sodium alginate, tragacanth, xanthan gums, tapioca, waxy maize, sago, arrowroot, cereal, gelling hydrocolloids, and any combination thereof. Examples of starches include, but are not limited to, starches derived from corn, wheat, pea, potato, tapioca, bamboo, and any modified version thereof. Examples of gelling hydrocolloids include, but are not limited to, selected from sodium alginate, sodium pectate, hydroxypropylcellulose, methylcellulose, methylhydroxypropylcellulose, methylethylcellulose, carrageenan, furcellaran, locust bean gum, gellan gum, curdlan, and any combination thereof. In some embodiments, the gelling agent can be selected from the group consisting of corn starch, potato starch, gelatin, agar, beef gelatine, gelling hydrocolloids, and a combination thereof. In some embodiments, the gelling agent can be selected from the group consisting of corn starch, potato starch, gelatin, agar, and a combination thereof.

The sweetener can be any suitable sweetener. For example, the sweetener can be a fluid sweetener, a dry sweetener, or combination thereof. Examples of fluid sweeteners include, but are not limited to, maple syrup, corn syrup, cane syrup, agave syrup, and any combination thereof. Examples of dry sweeteners include, but are not limited to, white sugar, brown sugar, golden sugar, raw cane sugar, coconut sugar, natural sugar, modified sugar, sucralose, sorbitol, saccharin, fructose, aspartame, glucose, sucrose, maltose, mannose, dextrose, fructose, lactose, trehalose, maltitol, lactitol, xylitol, sorbitol, mannitol, tagatose, glycerin, erythritol, isomalt, maltose, sucralose, neotame, alitame, neohesperidin dihydrochalcone, cyclamate, thaumatin, acesulfame potassium, saccharin, saccharin sodium, or any combination thereof. In some embodiments, the sweetener can be selected from the group consisting of maple syrup, cane syrup, corn syrup, golden sugar, agave syrup, raw cane sugar, and any combination thereof. In some embodiments, the sweetener can be selected from the group consisting of maple syrup, cane syrup, corn syrup, golden sugar, raw cane sugar, and any combination thereof.

The texturizing agent can be any suitable texturizing agent. Examples of texturizing agents include, but are not limited to, cooking oils, edible waxes, gelatine, pectin, starch (e.g. natural and/or modified), carrageenan, gum arabic, gellan gum, agar, and any combination thereof. Examples of modified starches include, but are not limited to, modified starches derived from corn, wheat, pea, potato, tapioca, bamboo, or any combination thereof. Examples of gelatine include, but are not limited to, gelatine derived from fish, bovine, pig, or any combination thereof. Examples of cooking oils include, but are not limited to, coconut oil, avocado oil, corn oil, cottonseed oil, olive oil, palm oil, peanut oil, rapeseed oil, canola oil, safflower oil, sesame oil, soybean oil, sunflower oil, nut oils, and vegetable oils. Examples of an edible wax include, but are not limited to, arnauba wax, candelilla wax, paraffin, castor wax, beeswax, stearic acid, stearyl alcohol, cetyl alcohol, esters of fatty alcohols, and any combination thereof. In some embodiments, the texturizing agent is selected from the group consisting of coconut oil, avocado oil, corn oil, cottonseed oil, olive oil, palm oil, peanut oil, rapeseed oil, canola oil, safflower oil, sesame oil, soybean oil, sunflower oil, nut oils, vegetable oils, carnauba wax, candelilla wax, paraffin, castor wax, beeswax, and any combination thereof. In some embodiments, the texturizing agent is selected from the group consisting of beeswax, vegetable oils, corn oil, coconut oil, canola oil, sunflower oil, and any combination thereof.

The alcoholic beverage contains one or more components therein. For example, alcoholised wine is an alcoholic beverage comprising a complex mixture of components such as, but not limited to, acids, alcohol (e.g. ethanol), sugars, phenols (e.g. tannins), and water. For example, dealcoholized beer is an alcoholic beverage comprising a complex mixture of components derived from ingredients such as, but not limited to, grains, hops, yeast, starch sources, and water. For example, non-alcoholic beer is an alcoholic beverage comprising a complex mixture of components derived from ingredients such as, but not limited to, grains, hops, yeast, starch sources, and water.

An example of an alcoholic beverage is wine. The wine can be any suitable kind of wine and is not limited to geographical region or quality. For example, the wine can be a red wine, a white wine, a rosé wine, a sparkling wine, a non-grape wine, or any combination thereof. For example, the wine can be a red wine only, a white wine only, a rosé wine only, a combination of red wine and white wine, or a combination or rosé wine and white wine. Examples of suitable wines include, but are not limited to, Shiraz, Moscato, and wines that have achieved quality and authenticity certification through the Vintners Quality Alliance (VQA) program. Other examples of suitable wines such as, but not limited to, Reisling, Ortega, Gewürztraminer, Malbec, Cabernet Sauvignon, Chardonnay, Pinot Noir, Syrah, Zinfandel, Sauvignon Blanc, Pinot Gris, Burgundy, and Vermouth can be used. Examples of non-grape wines include other fruit wines such as, but not limited to, blueberry wines and strawberry wines.

Other suitable alcoholic beverages include, but are not limited to, beer, spirits, liqueurs, and ciders. Examples of suitable beers include, but are not limited to, ales, lagers, stouts, porters, and malts. Examples of suitable spirits include, but are not limited to, gin, vodka, rum, whiskey (or whisky), tequila, moonshine, rectified spirits, and brandy. Examples of whiskeys include, but are not limited to, rye whiskey, bourbon, scotch, Tennessee whiskey, rye, and Irish whiskey. Examples of liqueurs include, but are not limited to, coffee liqueurs, fruit liqueurs, and cream liqueurs. Examples of ciders include, but are not limited to, still ciders and sparkling ciders. In some embodiments, the one or more components of an alcoholic beverage is derived from an alcoholic beverage selected from the group consisting of one or more wine, one or more beer, one or more spirit, one or more liqueurs, one or more cider, and any combination thereof. In some embodiments, alcohol (e.g. ethanol) is one of the one or more components derived from an alcoholic beverage, the one or more components forming a part of the gummy confectionery composition. In some embodiments, ethanol is not one of the one or more components derived from an alcoholic beverage, the one or more components of the alcoholic beverage forming a part of the gummy confectionery composition.

Over the course of manufacturing process of a gummy confectionery composition, one or more components may be removed entirely or partially from the formation of the gummy confectionery composition.

According to a second embodiment of a confectionery composition described herein, there is a gummy confectionery composition comprising: (i) a gummy matrix; and (ii) alcohol contained within the gummy matrix. For clarity, said alcohol is contained within the gummy matrix or forms a part of the gummy matrix.

The gummy matrix is derived from ingredients comprising a gelling agent, a sweetener, and a texturizing agent. As described later in this disclosure, the gelling agent, sweetener, and texturizing agent may be combined together in a suitable ratio for producing the gummy matrix.

The gelling agent can be any suitable gelling agent. For example, the gelling agent can be any gelling agent previously described in the first embodiment of the gummy confectionery composition.

The sweetener can be any suitable sweetener. For example, the sweetener can be any sweetener previously described in the first embodiment of the gummy confectionery composition.

The texturizing agent can be any suitable texturizing agent. For example, the texturizing agent can be any texturizing agent previously described in the first embodiment of the gummy confectionery composition.

The alcohol may be derived from an alcoholic beverage, as described in the first embodiment of the gummy confectionery composition. As contemplated in this second embodiment, however, the alcohol (e.g. ethanol) is not derived from an alcoholic beverage. Rather, the alcohol contemplated in this embodiment can be derived from an ethanol solution such as, but not limited to, reagent-grade ethanol that is commercially available through a chemical supplier (e.g. Sigma-Aldrich®, VWR International, Fisher Scientific, Spectrum Chemicals, Alfa Aesar). In other embodiments, such alcohol can be the collected by-product of sugar fermentation.

In other embodiments, the gummy matrix of the gummy confectionery composition is further derived from a weak acid, or conjugate thereof, in combination with a gelling agent, a sweetener, and a texturizing agent. For example, and with reference to gummy confectionery compositions derived from wine and without being bound by theory, it is believed that the weak acid or conjugate thereof protects anti-oxidants that are native to wines from degrading during the manufacturing process of the gummy confectionery composition. Examples of weak acids include, but are not limited to, acetic acid, ascorbic acid, citric acid, tartaric acid, oxalic acid, fruit acid, malic acid, lactic acid, glycolic acid, benzoic acid, succinic acid, threonic acid, glyceric acid, and any combination thereof. In some embodiments, the weak acid is selected from the group consisting of acetic acid, ascorbic acid, citric acid, tartaric acid, and any combination thereof. In some embodiments, the weak acid is selected from the group consisting of acetic acid, ascorbic acid, citric acid, and any combination thereof. In some embodiments, the weak acid is acetic acid. In some embodiments, the weak acid is ascorbic acid. In some embodiments, the weak acid is citric acid. In some embodiments, the weak acid is fruit acid. In some embodiments, the weak acid is benzoic acid. In some embodiments, the weak acid is lactic acid.

In other embodiments, the gummy confectionery composition further comprises natural flavour extracts for adjusting the taste of the confectionery composition. Examples of natural flavour extracts include, but are limited to, nettle leaf, purple carrot, orange, apple, cranberry, carrot, beet, spinach, watermelon, blueberry, strawberry, raspberry, mango, kiwi, peach, plum, pear, nectarine, black currant, Saskatoon berry, huckleberry, lime, pineapple, lemon, cherry, lime, apricot, haskap, saffron, lemongrass, ginger, lavender, caramel, maple, vanilla, espresso, chocolate, cinnamon, anise, and any combination thereof.

In other embodiments, the gummy confectionery composition is covered in a coating such as, but not limited to, a confectioner's glaze, chocolate, or other coating known in the confectionery industry.

The gummy confectionery composition is continuously solid, soluble in hot water, and entirely consumable. The gummy matrix of the gummy confectionery composition may be pulled or stretched. The gummy matrix may be cross-linked. It is believed that the gummy matrix is polymeric.

### Manufacturing the Gummy Confectionery Composition:

The present disclosure relates, in part, to a method of manufacturing a gummy confectionery composition comprising: (i) a gummy matrix; and (ii) one or more components derived from an alcoholic beverage and contained within the gummy matrix. For clarity, said one or more components is contained within the gummy matrix or forms a part of the gummy matrix. A non-limiting example of a component derived from an alcoholic beverage is ethanol.

The present disclosure also relates, in part, to a method of manufacturing a gummy confectionery composition comprising: (i) a gummy matrix; and (ii) alcohol contained within the gummy matrix. For clarity, said alcohol is contained within the gummy matrix or forms a part of the gummy matrix.

The gummy confectionery composition is manufactured by combining dry ingredients and fluid ingredients together in varying ratios and according to certain processing conditions.

In an embodiment of manufacturing a gummy confectionery composition comprising: (i) a gummy matrix and one or more components derived from an alcoholic beverage and contained within the gummy matrix; or (ii) a gummy matrix and alcohol contained within the gummy matrix; the following is provided.

Dry ingredients (e.g. gelling agents, dry sweeteners) are mixed together in a container (e.g. a saucepan or mixing bowl). Fluid sweeteners are then added and folded or mixed into the dry ingredients to form a first mixture. The first mixture is heated and brought to a simmer. The first mixture is maintained at a simmer for about 1 minute to about 240 minutes. For example, the simmer can be maintained for any time between about 1 minute to about 200 minutes, about 1 minute to about 150 minutes, about 1 minute to about 100 minutes, about 1 minute to about 50 minutes, about 1 minute to about 30 minutes, about 5 minute and about 20 minutes, about 5 minute and about 15 minutes, about 5 minute and about 10 minutes, about 6 minute and about 14 minutes, about 7 minute and about 13 minutes, about 8 minute and about 12 minutes, or about 9 minute and about 11 minutes. For example, the first mixture can be simmer for about 1, 10, 20, 30, 40, 50, 60, 70, 80, 90, 100, 110, 120, 130, 140, 150, 160, 170, 180, 190, 200, 210, 220, 230, 240 minutes, and any time period between about 1 minute and 240 minutes. For example, the first mixture can be simmered for about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50 minutes, and any time period between about 1 minute and about 50 minutes. In some embodiments, the first mixture is simmered for longer than 240 minutes. For example, the first mixture can be simmered for about 300 minutes, about 360 minutes, about 420 minutes, about 480 minutes, about 540 minutes.

After simmering, the first mixture is brought to a temperature between about 30° C. and about 90° C., and lower than the simmering temperature. For example, the temperature can be one that is between about 30° C. and about 90° C., about 30° C. and about 80° C., about 30° C. and about 70° C., about 30° C. and about 60° C., about 30° C. and about 50° C., about 30° C. and about 40° C., about 40° C. and about 90° C., about 40° C. and about 80° C., about 40° C. and about 70° C., about 40° C. and about 60° C., about 40° C. and about 50° C., about 50° C. and about 90° C., about 50° C. and about 80° C., about 50° C. and about 70° C., about 50° C. and about 60° C., about 60° C. and about 90° C., about 60° C. and about 80° C., about 60° C. and about 70° C., about 70° C. and about 90° C., about 70° C. and about 80° C., or about 80° C. and about 90° C. For example, the temperature can be about 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., and 90° C.

Fluid ingredients (e.g. alcoholic beverage, weak acids, texturizing agents, edible waxes, natural flavour extracts, ethanol solution) are separately mixed together and then combined with the first mixture to form a second mixture. The second mixture is not brought to a simmer. The second mixture is mixed to homogeneity at an elevated temperature between about 30° C. and about 90° C. In other methods, the second mixture is not mixed to homogeneity.

The second mixture is removed from heating and dispensed into moulds. In some methods, the moulds are maintained at room temperature (i.e. about 20° C. to about 25° C.) prior to addition of the second mixture therein. In some methods, the moulds are pre-cooled to a suitable temperature prior to addition of the second mixture therein. Suitable pre-cooled temperatures include, but are not limited to, temperatures within the ranges of about −20° C. to about 19° C., about −10° C. to about 15° C., about −10° C. to about 10° C., about −10° C. to about 5° C., about −10° C. to about 0° C., about −5° C. to about 15° C., about −5° C. to about 10° C., and about −5° C. to about 5° C.

The moulds containing the second mixture therein are then maintained or refrigerated at a suitable temperature, such as, but not limited to, a temperature between about −20° C. and 15° C. For example, the moulds containing the second mixture therein may be refrigerated at about −20° C., −19° C., −18° C., −17° C., −16° C., −15° C., −14° C., −13° C., −12° C., −11° C., −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., and 15° C. In other embodiments, the temperature of the moulds is brought down below −0° C. prior to dispensing the gummy confectionery composition therefrom.

The moulds containing the second mixture therein may be cooled for any suitable period of time, and until the gummy confectionery composition achieves a gummy consistency. For example, the cooling period may be any time between 1 minute and 24 hours. For example, the cooling period may be longer than 24 hours such as, but not limited to 30 hours, 36 hours, 48 hours, 60 hours, 72 hours.

In other embodiments, the fluid ingredients are added to the first mixture while the first mixture is still at a simmer, to form the second mixture. The second mixture is not brought to a simmer, and is mixed homogeneity at an elevated temperature between about 30° C. and about 90° C. In other embodiments, the second mixture is not mixed to homogeneity.

In other embodiments, the moulds containing the second mixture therein are cooled at room temperature. Gummy confectionery compositions obtain final form by setting at room temperature.

Different ratios of dry ingredients and fluid ingredients may be mixed together. An example of ratios of ingredients that may be mixed together are provided in Table 1 as follows:

TABLE 1

| | Percent by weight |
|---|---|
| | in manufacturing |
| | gummy |
| | confectionery |
| Ingredient | composition (wt %) |
| Alcoholic beverage | 10-60 |
| Sweetener | 20-70 |
| Gelling agent | 15-30 |
| Weak acid | 0.1-0.5 |
| Healthful ingredient | 0-4 |
| Texturizing agent | 0.5-5 |
| Natural flavor extracts | 0-1.5 |

In other examples, the second mixture comprises about 10 to about 55 wt %, about 10 to about 50 wt %, about 10 to about 45 wt %, about 10 to about 40 wt %, about 10 to about 30 wt %, about 10 to about 25 wt %, about 10 to about 20 wt %, about 15 to about 40 wt %, about 15 to about 35 wt %, about 15 to about 30 wt %, about 15 to about 25 wt %, or about 15 to about 20 wt % of the alcoholic beverage.

In other examples, the second mixture comprises about 20 to about 60 wt %, about 20 to about 50 wt %, about 30 to about 70 wt %, about 30 to about 60 wt %, about 30 to about 50 wt %, about 40 to about 70 wt %, about 40 to about 60 wt %, about 40 to about 50 wt %, about 45 to about 70 wt %, about 45 to about 60 wt %, about 45 to about 50 wt % of the sweetener.

In other examples, the second mixture comprises about 15 to about 25 wt %, about 20 to about 30 wt %, about 20 to about 25 wt % of the gelling agent.

Another example of ratios of ingredients that may be mixed together are provided in Table 2 as follows:

TABLE 2

| | Percent by weight |
|---|---|
| | in manufacturing |
| | gummy |
| | confectionery |
| Ingredient | composition (wt %) |
| Ethanol solution | 1-60 |
| Water | 1-60 |
| Sweetener | 20-70 |
| Gelling agent | 15-30 |
| Weak acid | 0.1-0.5 |
| Healthful ingredient | 0-4 |
| Texturizing agent | 0.5-5 |
| Natural flavor extracts | 0-1.5 |

In other examples, the second mixture comprises about 10 to about 45 wt %, about 10 to about 40 wt %, about 10 to about 30 wt %, about 10 to about 25 wt %, about 10 to about 20 wt %, about 15 to about 40 wt %, about 15 to about 35 wt %, about 15 to about 30 wt %, about 15 to about 25 wt %, or about 15 to about 20 wt % of the ethanol solution.

In other examples, the second mixture comprises about 20 to about 60 wt %, about 20 to about 50 wt %, about 30 to about 70 wt %, about 30 to about 60 wt %, about 30 to about 50 wt %, about 40 to about 70 wt %, about 40 to about 60 wt %, about 40 to about 50 wt %, about 45 to about 70 wt %, about 45 to about 60 wt %, about 45 to about 50 wt % of the sweetener.

In other examples, the second mixture comprises about 15 to about 25 wt %, about 20 to about 30 wt %, about 20 to about 25 wt % of the gelling agent.

A specific example of ratios of ingredients is provided in Table 3 as follows:

TABLE 3

| | Uncooked | Weight |
|---|---|---|
| | weight | percentage |
| Ingredients | (grams) | (wt %) |
| Red or white wine | about 160 | about 18.6 |
| Maple syrup | about 120 | about 13.9 |
| Cane syrup | about 120 | about 13.9 |
| Raw Cane Sugar | about 95 | about 11 |
| Corn Starch | about 75 | about 8.8 |
| Gelatin, Agar, or | about 68 | about 8 |
| beef gelatine | | |
| Golden Sugar | about 55 | about 6.4 |
| Potato Starch | about 40 | about 4 |
| Vinegar | about 40 | about 4 |
| Purple Carrot Juice | about 30 | about 3.5 |
| Natural Flavours | about 40-60 | about 4.7-7 |
| Vegetable Oil(s) | about 15 | about 1.7 |
| Edible Wax | about 12 | about 1.4 |
| Natural Acid Agents | about 3-7 | about 0.3-0.8 |
| Nettle Leaf Extract | about 6 | about 0.7 |

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

What is claimed is:

1. A gummy confectionery composition comprising: (i) a gummy matrix and one or more components derived from an alcohol containing solution, the one or more components contained within the gummy matrix; or (ii) a gummy matrix and alcohol contained within the gummy matrix.

2. A process of manufacturing the gummy confectionery composition of claim 1, the process comprising the steps of:
(a) mixing a gelling agent and a sweetener together to form a first mixture;
(b) heating the first mixture to a simmer;
(c) mixing the alcohol containing solution, a texturizing agent, and a weak acid into the first mixture, thereby forming a second mixture;
(d) maintaining the temperature of the second mixture to a temperature between about 30° C. and about 90° C.; and
(e) refrigerating the second mixture at a temperature between −20° C. and 15° C.

3. The process of claim 2, wherein the second mixture comprises 10 wt % to 60 wt % of the alcohol containing solution.

4. The process of claim 3, wherein the alcohol containing solution is an alcoholic beverage.

5. The process of claim 4, wherein the alcoholic beverage is selected from the group consisting of wine, beer, spirit, liqueur, cider, and a combination thereof.

6. The process of claim 5, wherein the alcohol beverage is wine.

7. The process of claim 6, wherein the wine is a red wine, a white wine, a rosé wine, non-grape wine, a sparkling wine, or a combination thereof.

8. The process of claim 5, wherein the spirit is selected from the group consisting of a gin, vodka, rum, whiskey, tequila, moonshine, brandy, and a combination thereof.

9. The process of claim 2, wherein the second mixture comprises 15 wt % to 30 wt % of the gelling agent.

10. The process of claim 2, wherein the second mixture comprises 20 wt % to 70 wt % of the sweetener.

11. The process of claim 2, wherein the second mixture comprises 0.1 wt % to 0.5 wt % of the weak acid.

12. The gummy confectionery composition of claim 2, wherein the first mixture is cooled to a temperature of between about 30° C. and about 90° C. prior to the addition of the alcohol containing solution into the first mixture.

13. A gummy confectionery composition comprising: (i) a gummy matrix and one or more components derived from an alcohol containing solution, the one or more components contained within the gummy matrix; or (ii) a gummy matrix and alcohol contained within the gummy matrix; the gummy confectionery composition prepared by a process comprising the steps of:
(a) mixing a gelling agent and a sweetener to form a first mixture;
(b) heating the first mixture to a simmer;
(c) mixing an alcohol containing solution and a texturizing agent with the first mixture, thereby forming a second mixture;
(d) maintaining the temperature of the second mixture to a temperature between about 30° C. and about 90° C.; and
(e) refrigerating the second mixture at a temperature between −10° C. and 15° C.

14. The gummy confectionery composition of claim 13, wherein the second mixture comprises 10 wt % to 60 wt % of the alcohol containing solution.

15. The gummy confectionery composition of claim 14, wherein the alcohol containing solution is an alcoholic beverage.

16. The gummy confectionery composition of claim 15, wherein alcoholic beverage is selected from the group consisting of wine, beer, spirit, liqueur, cider, and a combination thereof.

17. The gummy confectionery composition of claim 16, wherein the alcoholic beverage is wine.

18. The gummy confectionery composition of claim 13, wherein a weak acid is mixed with the first mixture and forms a part of the second mixture.

19. The gummy confectionery composition of claim 16, wherein the spirit is selected from the group consisting of a gin, vodka, rum, whiskey, tequila, moonshine, brandy, and a combination thereof.

20. The gummy confectionery composition of claim 13, wherein the first mixture is cooled to a temperature of between about 30° C. and about 90° C. prior to the addition of the alcohol containing solution into the first mixture.
